(19) United States
(12) Patent Application Publication
(10) Pub. No.: US 2026/0337099 A1
(43) Pub. Date: Oct. 29, 2026

(54) A METHOD FOR PRODUCING A PELLET

(71) Applicant: BINDING SOLUTIONS LTD, Middlesbrough (GB)

(72) Inventors: Richard JOYCE, Middlesbrough (GB); James HUNTER, Middlesbrough (GB)

(21) Appl. No.: 19/099,181

(22) PCT Filed: Jul. 27, 2023
(86) PCT No.: PCT/GB2023/051986

§ 371 Date: Jan. 28, 2025

(30) Foreign Application Priority Data
Jul. 28, 2022 (GB) 2211016.7

(51) Int. Cl. C04B 18/02; C04B 28/26

(52) U.S. Cl. CPC C04B 18/022; C04B 28/26

(57) ABSTRACT

A method of producing a pellet, which may comprise the steps of: mixing an organic binder with water to form an organic hydrogel binder; mixing the hydrogel with a particulate substrate selected from a metal ore, metal ore containing waste, metal fines, iron residue, iron filings, mineral waste, carbonaceous material, arc furnace waste or combinations thereof to form a substrate mixture; and forming an agglomerate. Alternatively, the method may comprise the steps of: providing a wet particulate substrate selected from a metal ore, metal ore containing waste, metal fines, iron residue, iron filings, mineral waste, carbonaceous material, arc furnace waste or combinations thereof; mixing the wet particulate substrate with an organic binder to form a wet substrate mixture; resting the wet substrate mixture to allow the formation of a hydrogel of the organic binder around the particulate substrate; and forming an agglomerate.

The invention relates to methods of producing pellets, in particular iron-containing pellets, from a particulate substrate and a hydrogel binder and to pellets obtained using these methods.

Though abundant in the Earth's core, the amount of carbon, and various metals and metal ores available is finite. There are environmental costs associated with mining metal ores and metals, such as iron, and smelting activities, particularly in terms of pollution. As a result, it is desirable to maximise the recycling of waste materials, which in turn reduces the waste that must be handled and stored, for instance, in the case of iron waste, typically by long term storage in heaps or ponds.

The production of pellets from particulate iron and other metal ores is generally known in the art. Often, such particles are bound together using a binder to form a pellet. In pelleting processes, binders are typically added as powders. However, powders can be difficult to process into pellets with a stable and sufficiently strong form that can be transported not only to the site of use, but within the large processing plants at their destination. Powder binders can also explode or easily escape into the atmosphere. This can be disadvantageous financially due to loss of material, can be hazardous because powders in the atmosphere can be inhaled.

In addition, pelleting processes using powders often give inconsistent results and can be problematic when production is upscaled due to difficulties in efficient powder dispersion in industrial scale mixers. There may also be interference between the binder components, as a result of temperature and pressure effects. The use of powders can also impact solubilization differentials in unpredictable ways. This means that significant testing is required before industrial scale use, making the transition from formulation to industrial pelleting more difficult and expensive.

Therefore, it would be desirable to develop a process for pelleting in which pellets have improved ease of manufacture without loss of strength and stability. The invention is intended to overcome or ameliorate at least some aspects of this problem.

Accordingly, in a first aspect of the invention there is provided a method of producing a pellet, the method comprising the steps of: mixing an organic binder with water to form an organic hydrogel binder; mixing the hydrogel with a particulate substrate selected from a metal ore, metal ore containing waste, metal fines, iron residue, iron filings, mineral waste, carbonaceous material, arc furnace waste or combinations thereof to form a substrate mixture; and forming an agglomerate.

In a second aspect of the invention there is provided a method of producing a pellet, the method comprising the steps of: providing a wet particulate substrate selected from a metal ore, metal ore containing waste, metal fines, iron residue, iron filings, mineral waste, carbonaceous material, arc furnace waste or combinations thereof; mixing the wet particulate substrate with an organic binder to form a wet substrate mixture; resting the wet substrate mixture to allow the formation of a hydrogel of the organic binder around the particulate substrate; and forming an agglomerate.

In a third aspect of the invention there is provided a pellet obtained by the method of the first or the second aspect of the invention, comprising a particulate substrate selected from a metal ore, metal ore containing waste, metal fines, iron residue, iron filings, mineral waste, carbonaceous material, arc furnace waste or combinations thereof and an organic hydrogel binder.

The processes according to the first and second aspects of the invention allow the binder to be more efficiently dispersed through the particulate substrate in the final pellet product. Without being bound by theory, it is believed that the formation of a hydrogel with the organic binder not only binds the substrate particles together, enhancing the strength of the final pellet, but also acts as a processing aid because in the hydrogel form, the binder is more dispersible and so can have lubricant effects. Overall, this improves the processing of the pellet, leading to more consistent results. Further, hydrogel binders are more easily dispersed than powder binders in industrial scale mixers. Accordingly, this leads to improved efficiency by reducing machine loading and overheating. Moreover, the final pellets produced in the process of the invention have been surprisingly found to be stronger, with higher strength and rigidity, relative to equivalent compositions in the absence of gelation, which reduces the need for post-production subsequent heating (e.g., drying or curing processes) of the pellet to stabilize it for storage, transport, and use. This has noticeable environmental benefits, in that less energy is required for the creation of a pellet of sufficient strength from the particulate material and introduces process efficiencies in that cold pelleting can be completed quickly, without the need for heating equipment or the delays that may be caused by an additional heating stage. Moreover, pellets obtainable by processes according to the first or second aspects of the invention also generally exhibit high thermal stability, which means that the pellet reduces to carbon at a controlled rate and does not disintegrate in the furnace.

Typically, the particulate substrate is selected from a metal ore, metal ore containing waste, metal fines, iron residue, iron filings, mineral waste, carbonaceous material, arc furnace waste or combinations thereof. Often, the particulate substrate is selected from a metal ore, metal ore containing waste, metal fines, iron residue, iron filings, carbonaceous material, arc furnace waste or combinations thereof. The particulate substrate is often sourced from the waste products of other industrial processes. The particulate substrate may comprise waste products from a single waste stream (in which variation will be in particle size only) or waste products from a combination of waste streams (in which mixed waste of different compositions will be present). This is environmentally beneficial as the recycling and reuse of such materials reduces the amount of finite resources that may otherwise go to waste.

The carbonaceous material may be coke, graphite, carbon black, peat, or coal. Often the carbonaceous material will comprise coke and/or coal. As used herein, the term “coal” is intended to include lignites, sub-bituminous coal, bituminous coal, steam coal and anthracite. Cokes have been found to be particularly problematic at forming pellets and so the invention offers a particular benefit in the provision of stronger coke pellets.

Mineral wastes may include mill scale, mill sludges, fines from ores and/or metal containing wastes.

Without being bound by theory, it is believed that whether the particulate substrate comprises a single waste type or a combination of different waste types, the use of a gel binder aids distribution of the wastes in a pseudomatrix before an agglomerate is formed prior to curing.

The metal may be, or the metal ore mineral waste may contain; iron, zinc, nickel, copper, chromium, manganese, gold, platinum, silver, titanium, tin, lead, vanadium, cadmium, beryllium, molybdenum, uranium, aluminium, or mixtures thereof; or elemental metal or in the form of, for example, oxides or silicates. Often the metal will be a transition metal, such as iron, zinc, nickel, copper, chromium, manganese, gold, platinum, silver, titanium, tin, lead, vanadium, cadmium, molybdenum, aluminium, or mixtures thereof, although the metal may also be uranium.

Often, the particulate substrate comprises a metal, and more often the particulate substrate comprises iron. The use of iron is advantageous due to the ready availability of iron and because it can be reused and recycled from the waste products of other processes to provide environmentally sustainable access to this material. Where the particulate substrate comprises a metal ore, often the ore will be an iron ore such as goethite, limonite, siderite, taconite, hematite or magnetite. Often, where the particulate substrate is a metal ore, it will be an iron ore, such as hematite or magnetite.

The particulate substrate may be a powder or filings, the term “filings” being given its common meaning in the art. Often the particulate substrate has a particle diameter of 4 mm or less (broadest axis). Often the particle diameter will be in the range 30 μm to 4 mm, often 50 μm to 3 mm or 0.1 mm to 2 mm. Often, at least 10 wt % of the particulate substrate is capable of passing through a 100 μm sieve prior to forming into a pellet. The presence of a range of particle sizes within the sample, improves the packing of the materials within the agglomerate during extrusion. The term agglomerate takes its usual meaning in the art, i.e., a particulate material formed from a collection of particles that are physically or chemically joined together.

Typically, the particulate substrate is added in an amount of about 70 wt % to about 99.9 wt % of the pellet, preferably about 80 wt % to about 99 wt %, more preferably about 90 wt % to about 95 wt %.

An auxiliary binder may also be present, such that a binder used in the methods described may comprise one or more organic binders, or a combination of the organic binder(s) and one or more auxiliary binders. Typically, the binder is present in the pellet in the range about 0.05 wt % to about 4 wt %, often in the range about 0.5 wt % to about 4 wt %, often in the range about 0.5 wt % to about 2.5 wt %.

Organic binders have the advantage that they can be used in a low concentration, and as such will not significantly affect the metallurgical or physical properties of the substrate mixture. The organic binder may be added in powder form, gel form or other pre-solubilised form (i.e., organic binder in a liquid suspension). In examples where the organic binder is added as a powder, water will be present to promote gelation of the organic binder in situ. Provision of the organic binder as a powder or a gel allows for good control of the overall water content of the pellet relative to liquid addition. Allowing the organic binder to form a gel (either before or after addition to the substrate), improves cold-strength of the pellet, reducing or removing the need for lengthy heating or drying processes and the energy input that such processes require. Such advantages may not be present if the organic binder does not form a hydrogel and instead, for example, takes the form of a film. An example of a situation in which the organic binder forms a film may be when the amount of water in the mixture is restricted, resulting in less dissolution of the organic binder in the water, preventing hydrogel formation.

Typically, the organic binder is selected from an organic resin (such as polyacrylamide resin), a cellulosic material (such as carboxymethyl cellulose (CMC), hydroxyethyl cellulose (HEC), or hydroxyethyl methyl cellulose (MHEC)), polyvinyl alcohol (PVA), a phenol-formaldehyde resin (such as resole resin, which is a base catalysed phenol-formaldehyde resin with a formaldehyde to phenol ratio of greater than one, usually around 1.5, or Novolac resin, which has a formaldehyde to phenol molar ratio of less than one) and/or a polysaccharide (such as starch, for example, wheat, maize, barley and potato starch, gum Arabic, guar gum or xanthan gum). Often the organic binder is selected from an organic resin, a cellulosic material, polyvinyl alcohol, and/or a phenol-formaldehyde resin.

Where the organic binder is a cellulosic material, it is often carboxymethyl cellulose (CMC). CMC is advantageous because it can be added in powder form which allows for control of the overall moisture content of the pellet. CMC also has a longer shelf-life than other plant derived organic binders. This is because other plant derived organic binders are often more susceptible to microbial attack and so break down more easily. Sometimes the organic binder may be hydroxyethyl methyl cellulose (MHEC), which has been found to have particularly good adhesive qualities and helps to enhance the strength of the pellet. However, as MHEC is highly water soluble, this can affect the shelf life of the final pellet, reducing this in comparison to pellets containing CMC.

Generally, the organic binder comprises carboxymethyl cellulose (CMC), polyacrylamide, a phenol formaldehyde resin, polyvinyl alcohol (PVA) or combinations of these organic binders with one another or with other organic binders such as those listed above. Alternatively, the organic binder may consist essentially of one or more of CMC, polyacrylamide, a phenol formaldehyde resin and/or PVA; consist of CMC, polyacrylamide, a phenol formaldehyde resin and/or PVA; or consist of just one of CMC, polyacrylamide, a phenol formaldehyde resin and/or PVA, for instance CMC or PVA.

Often, CMC may be used as an organic binder instead of, or in addition to, other organic binders, such that the organic binder may comprise about 10 wt % to about 100 wt %, often about 20 wt % to about 90 wt % or about 50 wt % to about 75 wt % CMC. Where the organic binder comprises CMC, it is typically added in the range of about 0.01 wt % to about 1.5 wt % of the pellet, often about 0.1 wt % to about 1 wt % of the pellet.

Typically, the CMC organic binder has an active polymer content of about 40% to about 90% and a pH in the range of about 5 to about 9, or about 6 to 8 when in solution. Further, the CMC will often be of molecular weight in the range of from about 3,000 to about 70,000. Optionally, the CMC will often be of molecular weight in the range of from about 10,000 to about 50,000. Without being bound by theory, it is believed that that, with lower molecular weights of CMC, for instance in the range about 10,000 to about 50,000, it is possible to prepare an organic binder solution of high concentration, which in turn can improve the strength of the pellets.

It will often be the case that the organic binder comprises polyvinyl alcohol (PVA). PVA may be used as an organic binder instead of or in addition to other organic binders, such that the organic binder may comprise about 10 wt % to about 100 wt %, often about 20 wt % to about 90 wt % or about 50 wt % to about 75 wt % PVA. Where the organic binder comprises PVA, it is typically added in the range of about 0.01 wt % to about 1.5 wt % of the pellet, often about 0.05 wt % or 1 wt % to about 1 wt % of the pellet.

Without being bound by theory, the PVA is believed to provide for rapid curing, and high strength as the polymer network formed by PVA is strong. Further, the process of pelleting with PVA excludes air from the mass material, which may reduce oxidation of the substrate where this is metal. Metal oxidation is undesirable for the simple reason that it reduces the amount of the metal (e.g. metallic iron) available for processing by the end user.

Polyvinyl alcohol is typically commercially formed from polyvinyl acetate by replacing the acetic acid radical of an acetate with a hydroxyl radical by reacting the polyvinyl acetate with sodium hydroxide in a process called saponification. Partially saponified means that some of the acetate groups having been replaced by hydroxyl groups and thereby forming at least a partially saponified polyvinyl alcohol residue.

Typically, the PVA has a degree of saponification of at least about 80%, typically at least about 5%, at least about 90%, at least about 95%, at least about 99% or about 100% saponification. PVA may be obtained commercially from, for example, Kuraray Europe GmbH, Germany. Typically, it is utilised as a solution in water. The PVA may be modified to include, for example, a sodium hydroxide content.

Typically, the PVA organic binder has an active polymer content of about 12% to about 13% and a pH in the range of about 4 to about 7 when in solution. Further, the PVA will often be of molecular weight in the range of from about 15,000 to about 150,000. Optionally, the PVA will often be of molecular weight in the range of from about 30,000 to about 120,000. Without being bound by theory, it is believed that that, with lower molecular weights, for instance in the range about 15,000 to about 60,000, it is possible to prepare an organic binder solution of high concentration, which in turn can improve the strength of the pellets.

Where the organic binder is a polysaccharide, this may be starch or amylase starch. For instance, it may be pregelatinised potato starch. It may be added in the amount of about 0.8 wt % of the final pellet, preferably about 0.6 wt %. The use of a polysaccharide as the organic binder may be desirable as polysaccharides often also function as thickening agents.

The organic binder (either alone, or in combination with one or more auxiliary binders) may be present in the range about 0.05 wt % to about 1.5 wt % of the pellet. Often, in the range about 0.07 wt % to about 1.0 wt %, or about 0.1 wt % to about 0.9 wt %. It has been found that where less than about 0.05 wt %, of the organic binder is present, the structural integrity of the agglomerate is low.

In the method of the first aspect of the invention, the organic binder is mixed with water to form an organic hydrogel binder.

As used herein, the term “hydrogel” means a material which is not a readily flowable liquid and not a solid but a gel which is comprised of a gel forming material, such as a hydrophilic polymer that does not dissolve in water. In other words, the hydrogel may be a semi-solid substance. Typically, hydrogels are formed through a gel forming material, such as a hydrophilic polymer forming an interconnected, crosslinked network which can entrap, absorb and/or otherwise hold water and thereby create a gel. Some hydrogels can be diluted with another liquid such as water, which disrupts the interconnected network, resulting in a solution, although typically the hydrogels of the invention will be crosslinked hydrogels that do not dissolve on dilution.

Typically, the amount of water in the hydrogel is in the range about 1 wt % to about 5 wt %, or about 2 wt % to about 4 wt %, or about 2.5 wt % to about 4.5 wt %, or about 3 wt %. Without being bound by theory, it is believed that not all of the water that is mixed with the organic binder before addition to the substrate is present in the final hydrogel. This is because small amounts act to ensure dissolution or mixing of other components.

The formation of the organic hydrogel binder may take in the range of about 20 minutes to about 2 hours, preferably about 30 minutes to about 1 hour. The time taken to form the organic hydrogel binder may be altered by factors such as additional processing, temperature (often in the range about 10 °C to about 60 °C, or about 15 °C to about 40 °C, or about 20 °C to about 30 °C for optimal solubilisation), grade selection of CMC, grade selection of iron ore and mixing. At these temperatures, the pellets formed were found to be particularly strong relative to pellets of the same formulation but which were not processed via gel formation.

In the method of the second aspect of the invention, the resting of the wet substrate mixture allows the formation of a hydrogel of the organic binder around the particulate substrate. As used herein, the term “resting”, or “souring”, is given its common meaning in the art, i.e., wherein the wet substrate mixture is left without outside interference such as heating, shear or mixing for a sufficient period of time for the organic binder and particulate substrate to form a hydrogel.

Without being bound by theory, as above with regard to the first aspect of the invention, it is believed that not all of the water that is associated with the wet substrate is present in the final hydrogel. This is because small amounts act to ensure dissolution or mixing of other components.

Typically, the ratio of organic binder to particulate substrate is about 0.1% to about 0.8% organic binder to about 99.9% to about 99.2% particulate substrate, preferably about 0.15% to about 0.5% organic binder to about 99.85% to about 99.5% particulate substrate.

The resting of the wet substrate mixture to allow formation of a hydrogel of the organic binder around the particulate substrate may take in the range of about 5 minutes, 15 minutes or 30 minutes to about 2 days, often 1 hour to 1 day (i.e. 24 hours) or less than one day, for instance 9, 6 or 3 hours. The time required being dependent upon the nature of the binders selected. It is often the case that the resting time is in the range 15 minutes to about 2 hours, particularly where an auxiliary binder is present. For instance, cellulosic materials often form gels after resting for a period of hours, for instance 15 minutes to 3 hours, or 1 to 2 hours. Whereas, organic resins and phenol-formaldehyde resins can beneficially be allowed to rest for longer, for instance 3 hours to 2 days, or 6 hours to 1 day.

The methods of the invention may further comprise the step of adding an auxiliary binder to the substrate mixture. The substrate mixture may be a dry substrate mixture of the first aspect of the invention or a wet substrate mixture of the second aspect of the invention.

The auxiliary binder forms bonds with the particulate substrate, for example iron ore, which allows the final pellet to withstand heat and pressure during furnace transit.

Typically, the auxiliary binder comprises an inorganic binder. The inorganic binder may comprise one or more silicates, (for example, a silicate in the form of its sodium salt), or refractory materials including, but not limited to, oxides, carbides, or nitrides of silicon, aluminium, magnesium, calcium, and zirconium and combinations thereof.

For example, the refractory material may comprise alumina, fireclays, bauxite, chromite, dolomite, magnesite, silicon carbide, zirconia, or combinations thereof. As used herein, the term “refractory material” refers to materials that are resistant to thermal stress, high pressure, or corrosion by chemical reagents.

Often, the inorganic binder comprises one or more silicates. Often, the inorganic binder comprises two to four different silicates. The one or more silicates may be in liquid form, powder form, or a combination thereof. It may be the case that the auxiliary binder is in powder form.

Often, the inorganic binder (either alone or in combination with one or more organic binders) is present in the pellet in the range of from about 0.5 wt % to about 2.5 wt %, often, in the range about 1 wt % to about 2 wt %, or about 1.25 wt % to about 1.75 wt %.

When silicates are present, and the one or more silicates is in liquid form, it will often be present in greater amounts because there is a lower level of active in liquid silicates than in powder silicates. Where the one or more silicates is in liquid form, it is often present in the pellet the range of from about 0.5 wt % to about 2.5 wt %, often about 1 wt % to about 2 wt %, or about 1.25 wt % to about 1.75 wt %.

Where the one or more silicates is in powder form, it is often present in the pellet in the range of from about 0.5 wt % to about 2.5 wt %, often, in the range about 1 wt % to about 2 wt %, or 1.25 wt % to about 1.75 wt %.

The methods of the invention may further comprise the step of adding one or more additional additives to the substrate mixture.

As described above, the hydrogel formed with the organic binder may act as a processing aid. The methods of the invention may optionally further comprise the step of adding a separate processing aid to the substrate mixture. The processing aid includes but is not limited to weak solutions of cationic, anionic, or non-ionic polymers, typically acrylic based flocculants, carbon (often in the form of graphite), lubricants, surfactants (such as sodium lauryl sulfate), stearates (such as calcium stearate or sodium stearate), stabilising fibres or combinations thereof. A processing aid can render the overall process more efficient, which in turn saves both cost and energy.

The step of forming the pellet may comprise extruding the agglomerate. The extrusion process may take place at a temperature in the range of about 30 °C to about 70 °C, often in the range of about 35 °C to about 55 °C. Further the process may take place at atmospheric pressure or under vacuum. As used herein, the term “under vacuum” takes its normal meaning in the art, in that the extrusion process may be conducted at pressure less than atmospheric pressure.

The step of forming the pellet may comprise cold-forming the agglomerate. The term “cold-formed” means, for example, without curing, sintering, or heating to above about 60 °C or above about 40 °C or about 30 °C. In other words, it may often be the case that if there is an application of heat during agglomerate formation, only low levels of heat will be applied. Further, when the agglomerate is pelletised, although frictional heat may be generated by any pressing and/or extrusion processes used, and the binder may undergo exothermic reactions in situ, this will sometimes be the only heat applied. These inherent heating mechanisms would not be expected to generate enough heat to impact the formation of the pellet.

Alternatively, it may be the case that low level heat, such as heating in the range of from about 100 °C to about 250 °C is applied. Low level heating allows for faster forming of the pellet and may be in the range about 100 °C to about 250 °C, or often about 150 °C to 200 °C. When low level heating is applied, it may be applied for a period in the range about 1 minute up to about 24 hours. The application of heat generally promotes drying and curing of the pellet ensuring that it is ready for transport and use when needed. The skilled person would understand and appreciate that factors such as the external ambient temperature, nature of the components in the formulation, and the desired properties of the pellets to be produced (e.g., a low water content) would impact whether external heat is required, the level of heat that is applied and for what period of time. Therefore, the skilled person would consider such factors when determining the period of time and level of heat to apply in the process, for instance, it may be that providing an environment of around 30 °C to 50 °C (either based on external ambient temperature or warmed) for 6 to 24 or 9 to 18 hours could assist pellet formation. Alternatively, heating in the range 125 °C to 175 °C for a shorter period of time, for instance 1 minutes to 3 hours, or 15 minutes to 100 minutes may be desirable. As such, it may be that the agglomerate and then the pellet are either cold-formed or formed with the application of low level heating, such that they would be formed at temperatures in the range of about 10 °C to about 250 °C, or about 15 °C to about 200 °C, or about 20 °C to about 150 °C.

The advantage of cold-forming, or forming with only low levels of heat, is significant, in terms of reduction in energy expenditure relative to the induration manufacture techniques commonly used. There is also no need for high-temperature furnaces to produce the pellet, resulting in a simpler and more economically and environmentally beneficial manufacturing process.

Traditionally, pellets were formed using heat processes producing so-called, hot bonded (indurated) briquettes. In induration techniques, initially, a “green” pellet is formed from the combination of particulate substrate and a binder, which is then shaped into a pellet (often using a pelletiser). As used herein, the term “green pellet” takes its usual meaning in the art and refers to a pellet that does not yet have the required strength for its end use and requires further treatment or processing. The green pellets are hardened via a series of steps including drying, pre-heating, firing, and cooling of the green pellets. Removal of water in a controlled manner prevents crack formation and maintains the structural integrity of the pellet. The temperature range of the drying stage is dependent on the chemical and physical properties of the green pellet; however, it is likely to be in the range of 100 °C to 250 °C for 5 to 10 minutes. The pre-heating stage usually takes place using a ramped heating process from around 300 °C to 350 °C for 10 to 15 minutes, to up to around 1250 °C to 1350 °C. The pre-heating stage ensures that any metal hydrates or metal carbonates present decompose to their anhydrous forms. Decomposition of these types of compounds helps to improve the structural integrity of the resultant pellet by removing water and/or gas which can react causing overpressure and cracking of the pellet during firing. The firing stage will often take place at temperatures greater than 1350 °C for roughly 10 to 20 minutes (for typical capacities such as 250 to 500 tph) and will result in the sintering of the pellet, providing the strength needed to render it suitable for its end use. During the sintering process, the bonds within the pellet are formed by recrystallisation and bridging, creating ceramic bonds and the formation of macro voids which allow for some expansion and stress relief. As used herein, the term “macro void” relates to voids within the pellet and have a size ranging from about 50 μm to about 1 mm in diameter. The void formation is particularly important where the briquette is a metal ore briquette, as reduction of the metal (for instance the hematite to magnetite conversion in iron ore) causes volume changes and stresses on the briquette. As macro void formation does not occur without firing, alternative methods are needed to prevent disintegration of the pellet when placed under internal stress. The gelation techniques described herein provide such an alternative by offering improved chemical bonding strength.

Further, relative to the processes of the invention, induration processes are uneconomical as they are complex, must be executed with care and require the application of significant heat. For instance, the raw material preparation is critical. The components of the green pellet must be an appropriate size range, surface area, and moisture content in order to withstand the process as surface chemistry plays a significant role. Moreover, as the process involves multiple heating stages, it requires a great deal of energy. As such, there is a need for a pellet production process that is less energy intensive and more cost effective. Moreover, there is a need for a process where there is more flexibility in the physical state of the particulate material used, and which results in the generation of pellets having comparable or even superior physical properties to those generated using an induration process. The methods of the invention, through their use of hydrogel binders help to offer a solution to this problem.

In the method according to the second aspect of the invention, the wet particulate substrate may comprise water in the range of from about 1 wt % to about 40 wt %, preferably from about 3 wt % to about 25 wt %, more preferably from about 5% to about 15%.

The pellet obtained by either of the methods of the first and second aspects of the invention may be cold-formed or formed by low-level heating, such as in the temperature range 10 °C to 250 °C.

Typically pellets according to the third aspect of the invention have an average volume in the range 2.5 to 15 cm³, often in the range 3 to 12 cm³, or 7 to 11 cm³. The pellets will generally be sized to minimise surface area, and will often be, for instance roughly spherical, ovoid, cylindrical or cubic structures.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”. The term “wt %” and analogous terms is intended to mean the percentage of raw material by weight in the final pellet by weight. If additives, impurities, and/or water are present in the particulate starting material in step (i), the term “wt %” includes said additives, impurities and/or water.

In order that the invention may be more readily understood, it will be described further with reference to the figures and to the specific examples hereinafter.

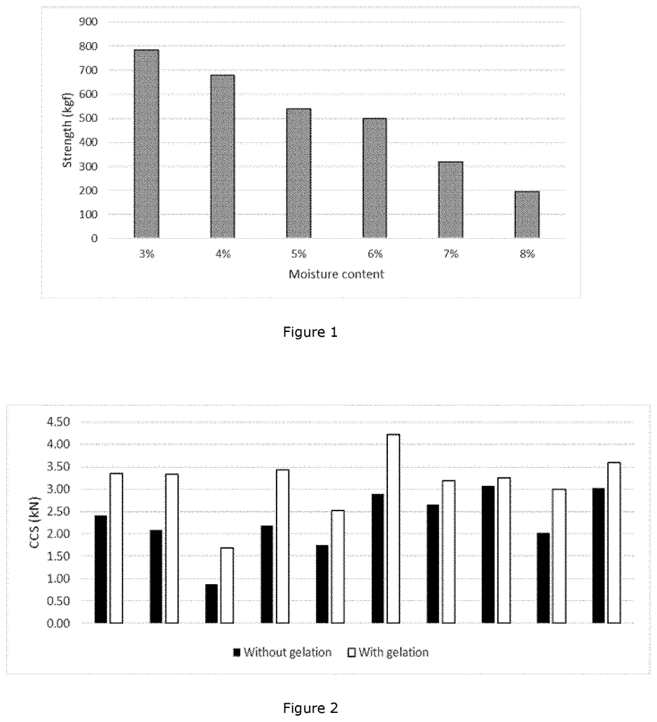

FIG. 1 illustrates the results of moisture content variation on Cold Crush Strength (CCS) for carboxymethyl cellulose;

FIG. 2 illustrates the results of repeated CCS testing. The pellets represented by the black bars comprise 0.5 wt % of CMC added to a >68 wt % Fe concentrate without a pre-gelation step and the white bars comprise 0.5 wt % of CMC added to a >68 wt % Fe concentrate, with a pre-gelation step wherein the CMC is added to water and forms a hydrogel before being added to the >68 wt % Fe concentrate, according to the invention; and

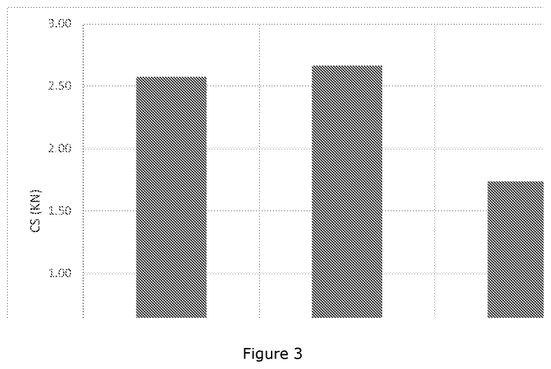

FIG. 3 illustrates the results of temperature variation on CCS for CMC.

### EXAMPLES

### Example 1—Roller Pressed Pellet Formation (Pre-Gelation)

CMC powder was mixed with water in a ratio of 1 part CMC to 16 parts water at 30 °C until all of the powder had dissolved and a gel had developed. The temperature was maintained at 30 °C. 600 g of the resulting organic hydrogel binder was mixed with 7.5 kg of dry hematite >65 wt % Fe iron ore (dried to constant mass at 105 °C) for 3 minutes in a high shear mixer at 45 rpm. Sodium silicate was added before the mixture was mixed for a further 3 minutes. The resulting substrate mixture was formed into an agglomerate using a hutt roller press to produce ovoid roller pressed pellets (approximately 15×26×36 mm, 11.2 cm³) and cured at 40 °C for 24 hours. The resulting pellets contained 0.25 wt % CMC and 2 wt % silicate.

### Example 2—Roller Pressed Pellet Formation (Pre-Gelation)

The method of example 1 was repeated using magnetite iron ore >68 wt % Fe (the moisture content of the >68 wt % Fe was adjusted to 8% so that the total water content in the system was the same as the total water content in the system of Example 1).

### Comparative Example 3—Roller Pressed Pellet Formation (Powder Binder)

The method of example 1 was repeated using hematite iron ore but without the gelation of CMC prior to addition to the >65 wt % Fe iron ore (dried to constant mass at 105 °C to provide for pellets with the same moisture content as example 1).

### Comparative Example 4—Roller Pressed Pellet Formation (Powder Binder)

The method of example 1 was repeated using magnetite iron ore but without the gelation of CMC prior to addition to the >68 wt % Fe iron ore (the moisture content of the >68 wt % Fe was adjusted to 8% so that the total water content in the system was the same as the total water content in the system of Example 1).

### Example 5—Roller Pressed Pellet Formation (Pre-Gelation)

The method of example 1 was repeated without the subsequent addition of sodium silicate, such that the resulting pellets contained 0.25 wt % CMC.

### Example 6—CCS Testing

CCS of each of examples 1, 2 and 5 and comparative examples 3 and 4 were determined using standard methodology according to ISO 4700:2015 Using a Mecmesin Omnitest Materials Tester 10). The results are provided in Table 1 below.

TABLE 1

| Example | Binder Used | Substrate | CCS (kgf) |
|---|---|---|---|
| 1 | CMC + silicate | Hematite | 337 |
| 2 | CMC + silicate | Magnetite | 478 |
| 3 | CMC + silicate | Hematite (comparative) | 316 |
| 4 | CMC + silicate | Magnetite (comparative) | 303 |
| 5 | CMC | Hematite | 198 |

Table 1 clearly shows that where the binder is gelled prior to addition to the substrate the CCS is higher than using comparative, conventional, techniques. It was also observed that with CMC alone, robust pellets could be prepared of CCS just under 200 kgf, a significant increase in strength relative to typical values for CMC without gelation which tend to fall in the range 30-50 kgf and are prone to disintegration. It was also observed that where the moisture content of the substrate increases, this has a negative impact on the CCS. This is shown in FIG. 1.

### Example 7

CCS testing using standard methodology according to ISO 4700:2015 using Mecmesin Omnitest Materials Tester 10) was conducted for two sample types of cylindrical pellets (approximately 16 mm diameter×16 mm length, 3.2 cm³) which comprised 0.5% by weight of CMC added to >68 wt % Fe concentrate. The first sample type included a pre-gelation step, the second used conventional techniques. 10 different grades of CMC were tested (from three different suppliers).

The results are provided in FIG. 2, wherein different grades of CMC are compared under the same conditions. The black bars represent pellets formed without gelation of CMC prior to addition to the >68 wt % Fe concentrate, and the white bars represent pellets formed with gelation of CMC prior to addition to the >68 wt % Fe concentrate. This data is therefore broadly equivalent to the test data for Examples 1 (with gelation) and 4 (without gelation).

As shown in FIG. 2 (where “strength” on the y-axis corresponds to the CCS in kilonewton (kN) wherein 1 kgf=0.0098 kN), in all cases where the pellets were formed with a gelation step (represented by the white bars) improved CCS is demonstrated relative to pellets formed without a gelation step.

### Example 8—Temperature of Gel Formation (Pre-Gelation)

A series of experiments were carried out to determine the optimum temperature of solubilisation for a 30,000 molecular weight grade CMC as illustrative of an organic binder. The CMC was processed by adding powder to water at 20 °C, 30 °C, 40 °C and 50 °C in the weight ratio of 1:16 until a gel formed. The resultant gels were used in standard formulations at 8% solution addition to magnetite iron ore >68 wt % Fe, to produce cylindrical test pellets (approximately 16 mm diameter×16 mm length, 3.2 cm³) which were tested for CCS according to ISO 4700:2015 and using Mecmesin Omnitest Materials Tester 10). The results are shown in FIG. 3. As can be seen, it was found that the optimal temperatures for solubilisation are lower temperatures, for instance in the range 15 °C to 35 °C, the highest strengths being observed at 20 °C or 30 °C, 30 °C offering the best results.

### Example 9—Roller Pressed Pellet Formation (In Situ)

0.3 wt % of CMC was mixed with 7.5 kg of hematite >65 wt % Fe iron ore with a water content of 5.5% (wet iron ore) for 3 minutes in a high shear mixer at 45 rpm. The resulting wet substrate mixture was rested for 1 hour at ambient temperature (in the range 20 °C to 25 °C) allowing a hydrogel of CMC to form around the iron ore. 2 wt % sodium silicate was added before the mixture was mixed for a further 3 minutes. The substrate mixture was then formed into an agglomerate using a hutt roller press to produce ovoid roller pressed pellets (approximately 15×26×36 mm, 11.2 cm³) and cured at 40 °C for 24 hours.

### Example 10—Roller Pressed Pellet Formation (In Situ)

The method of example 9 was repeated using magnetite iron ore >68 wt % Fe.

### Comparative Example 11—Roller Pressed Pellet Formation (In Situ)

The method of example 9 was repeated using hematite >65 wt % Fe iron ore but without the resting stage, and so without the formation of the hydrogel around the iron ore.

### Comparative Example 12—Roller Pressed Pellet Formation (In Situ)

The method of example 9 was repeated using hematite magnetite iron ore >68 wt % Fe but without the resting stage, and so without the formation of the hydrogel around the iron ore.

### Example 13—CCS and Tumble Index Testing

CCS and Tumble Index (TI) of each of examples 9, 10 and comparative examples 11 and 12 were determined using standard methodology according to ISO 4700:2015 using a Mecmesin Omnitest Materials Tester 10 and ISO 3271:1995 respectively). The results are provided in Table 2 below.

TABLE 2

| Example | Substrate | CCS (kgf) | TI |
|---|---|---|---|
| 9 | Hematite | 450 | 90 |
| 10 | Magnetite | 405 | 95 |
| 11 | Hematite (comparative) | 334 | 85 |
| 12 | Magnetite (comparative) | 303 | 88 |

Table 2 clearly shows that where the binder and substrate mixture is rested to allow formation of a gel, the CCS is higher than using comparative, conventional, techniques. In addition, the tumble index of the samples is higher, indicating a more robust pellet is formed. The industry standard for TI is in the range 90 to 95, examples 9 and 10 fulfill the industry standard, comparatives example 11 and 12 do not.

### Example 14—Roller Pressed Pellet Formation (In Situ)

0.5 wt % of polyacrylamide (two different grades) were mixed with 7.5 kg of magnetite iron ore (>68 wt % Fe) with a water content of 5.5% (wet iron ore) for 3 minutes in a high shear mixer at 45 rpm. The resulting wet substrate mixture was rested for the times shown in Table 3 below at ambient temperature (in the range 20 °C to 25 °C) allowing a hydrogel of polyacrylamide to form around the iron ore. In some examples, 2.0 wt % sodium silicate was added before the mixture was mixed for a further 3 minutes. The substrate mixture was then formed into an agglomerate using a hutt roller press to produce “square” roller pressed pellets (approximately 15×26×36 mm, 2.5 cm³) and cured at 40 °C for 24 hrs.

TABLE 3

| | | Avg CCS (kgf) | Avg CCS (kgf) |
|---|---|---|---|
| Binders Used | Time | Grade 1 | Grade 2 |
| Silicate + Polyacrylamide | None | 355 | 473 |
| (comparative) | | | |
| Silicate + Polyacrylamide | 30 mins | 447 | 513 |
| Silicate + Polyacrylamide | 60 mins | 465 | 527 |
| Polyacrylamide | 30 mins | 70 | 75 |
| Polyacrylamide | 60 mins | 121 | 153 |
| Polyacrylamide | 1 day | 140 | 245 |

As can be seen higher strengths are generally observed with resting for both the polyacrylamide only and the silicate/polyacrylamide systems, and that improvements can be observed with resting periods of as little as 30 minutes. However, when silicate is absent the polyacrylamide requires longer to form strong bonds (values of over 60 provide for use without disintegration), up to one day. It is generally the case that the presence of silicate markedly increases strength relative to polyacrylamide alone, indicating the benefits of the auxiliary binders of the invention.

### Example 15—Roller Pressed Pellet Formation (In Situ)

The method of Example 14 was repeated using 0.5 wt % polyvinyl alcohol with 0.5 wt % phenol formaldehyde resin where the polyvinyl alcohol is provided in dry form. The results are shown in Table 4 below.

TABLE 4

| Binders Used | Time | CCS (kgf) |
|---|---|---|
| PVA + phenol formaldehyde resin | None | 20 |
| (comparative) | | |
| PVA + phenol formaldehyde resin | 30 mins | 46 |
| PVA + phenol formaldehyde resin | 60 mins | 58 |
| PVA + phenol formaldehyde resin | 1 day | 103 |
| PVA | 30 mins | 26 |
| PVA | 60 mins | 40 |
| PVA | 1 day | 65 |

As can be seen, strengths are markedly increased where gel formation is provided relative to where no gel is formed (increasing for PVA alone from 26 kgf to 65 kgf, and for PVA+phenol formaldehyde resin from 20 kgf to 103 kgf). At strengths of 20 kgf, the pellet can be formed, but would not remain intact. The gelation step enables stable pellets to be formed using PVA alone, and the combination of PVA and phenol formaldehyde provides additional strength.

Similar results are achieved when polyvinyl alcohol is provided in liquid form.

It would be appreciated that the process and apparatus of the invention are capable of being implemented in a variety of ways, only a few of which have been illustrated and described above.

1. A method of producing a pellet, the method comprising the steps of:
a. Mixing an organic binder and an inorganic binder with water to form an organic hydrogel binder, wherein the inorganic binder is added in the amount of about 0.5 wt % to about 2.5 wt % of the substrate mixture;
b. Mixing the hydrogel with a particulate substrate comprising iron selected from a metal ore, metal ore containing waste, metal fines, iron residue, iron filings, mineral waste, carbonaceous material, arc furnace waste or combinations thereof to form a substrate mixture; and
c. Forming an agglomerate.

2. A method of producing a pellet, the method comprising the steps of:
a. Providing a wet particulate substrate selected from a metal ore, metal ore containing waste, metal fines, iron residue, iron filings, mineral waste, carbonaceous material, arc furnace waste or combinations thereof;
b. Mixing the wet particulate substrate with an organic binder and an inorganic binder to form a wet substrate mixture, wherein the organic binder is selected from an organic resin, a cellulosic material, polyvinyl alcohol, a phenol-formaldehyde resin, or a combination thereof, and wherein the inorganic binder is added in the amount of about 0.5 wt % to about 2.5 wt % of the substrate mixture;
C. Resting the wet substrate mixture to allow the formation of a hydrogel of the organic binder around the particulate substrate; and
d. Forming an agglomerate.

3. The method of claim 2, wherein the wet particulate substrate comprises a metal.

4. The method of claim 2, wherein the wet particulate substrate comprises iron.

5. The method of claim 1, wherein the particulate substrate is added in an amount of about 70 wt % to about 99.9 wt % of the pellet.

6. The method of claim 1, wherein the organic binder is selected from an organic resin, a cellulosic material, polyvinyl alcohol, a phenol-formaldehyde resin and/or a polysaccharide.

7. The method of claim 6, wherein the organic binder comprises carboxymethyl cellulose (CMC), polyvinyl alcohol (PVA) or combinations thereof.

8. The method of claim 1, wherein the organic binder is added in the amount of about 0.05 wt % to about 1.5 wt % of the pellet.

9-10. (canceled)

11. The method of claim 1, wherein the inorganic binder comprises one or more silicates, or refractory materials including, oxides, carbides, or nitrides of silicon, aluminium, magnesium, calcium, and zirconium and combinations thereof.

12. The method of claim 11, wherein the inorganic binder comprises one or more silicates.

13. The method of claim 1, wherein the inorganic binder is in powder form.

14-15. (canceled)

16. The method of claim 1, wherein the organic hydrogel binder is formed at a temperature in the range of about 10 °C to about 60 °C.

17. The method of claim 1, wherein the step of forming the pellet comprises extruding the agglomerate.

18. The method of claim 1, wherein the step of forming the pellet comprises heating the agglomerate to a temperature in the range 10 °C to 250 °C.

19. The method of claim 2, wherein the wet particulate substrate comprises water in the range of from about 1 wt % to about 40 wt %.

20. A pellet obtained by the method of claim 1 comprising a particulate substrate, an organic binder, and an inorganic binder, wherein the organic binder and inorganic binder are mixed with water to form a hydrogel binder.

21. The pellet of claim 20, wherein the pellet is heated to a temperature in the range 10 °C to 250 °C.
